(19) United States
(12) Patent Application Publication
(10) Pub. No.: US 2012/0192287 A1
(43) Pub. Date: Jul. 26, 2012

(54) TEXT MESSAGE SECURITY

(76) Inventors: Yigang Cai, Naperville, IL (US); Suzann Hua, Lisle, IL (US)

(21) Appl. No.: 13/013,650

(22) Filed: Jan. 25, 2011

(51) Int. Cl. G06F 21/24

(52) U.S. Cl. 726/28

(57) ABSTRACT

Systems and methods are provided for protecting text messages. A sending device inserts security information in a text message, and sends the text message to a receiving device. The receiving device detects an attempt by an end user to access the text message. When this occurs, the receiving device parses the text message to identify the security information inserted in the text message, and controls access to the text message by the end user based on the security information.

### FIELD OF THE INVENTION

The invention is related to the field of communications and, in particular, to security or protection mechanisms for text messages.

### BACKGROUND

Text messaging has become a popular mode of communication in many mobile (or wireless) networks. One example of text messaging is Short Message Service (SMS), which is a set of communication protocols allowing the exchange of short text messages (i.e., 160 characters or less) between devices. While the term “text message” traditionally referred to text-only messages sent using SMS, it has been extended to include multimedia messages, such as images, video, sound content, etc. The multimedia messages may be sent using Multimedia Message Service (MMS) protocol. Often times, mobile users more frequently use text messaging for communication than voice calls.

When a sender of a text message sends the message to a recipient, the text message is delivered to the recipient's device and placed into an inbox for text messages. The recipient may then view the received text messages that are placed in the inbox. Some of the received text messages may include sensitive information, such as financial, business, medical, personal, family, etc. Unfortunately, any person can view the text messages in the inbox if they have possession of the device.

### SUMMARY

Embodiments described herein provide security for text messages. The individual text messages received by a recipient's device may include security information, such as a password, an authorized time, etc. Before an end user is permitted to access a text message from an inbox of the recipient's device, the device determines whether the text message includes the security information. If so, the end user will have to enter a valid password, access the text message during an authorized time, or meet other conditions set forth in the security information before the text message may be viewed or otherwise accessed. Thus, individual text messages may be protected from being viewed by unauthorized users of a recipient's device. The sender can essentially control who can view the text messages once they are received at the recipient's device based on the security information.

One embodiment comprises a sending device for a text message. When in operation, the sending device identifies a text message for delivery over a communication network to a receiving device. The sending device facilitates insertion of security information in the text message, such as in the header or body of the text message. The security information controls access to the text message by an end user of the receiving device, such as a password, an authorized time during which access is allowed, etc. The sending device then transmits the text message with the inserted security information for delivery to the receiving device.

Another embodiment comprises the receiving device. When in operation, the receiving device receives the text message from the sending device. The receiving device detects an attempt by the end user to access the text message, and parses the text message responsive to the access attempt to identify the security information inserted in the text message. The receiving device then controls access to the text message by the end user based on the security information. The receiving device may control access by determining whether the end user is authorized to access the text message based on the security information, and allowing or denying access to the text message based on whether the end user is authorized.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates a communication system in an exemplary embodiment.

FIG. 2 is a flow chart illustrating a method of associating security information with a text message in an exemplary embodiment.

FIGS. 3A-B are flow charts illustrating a method of controlling access to a text message based on security information in an exemplary embodiment.

FIG. 4 illustrates a communication system in another exemplary embodiment.

FIG. 5 illustrates a sending UE displaying security information entered into an SMS message in an exemplary embodiment.

FIG. 6 illustrates a receiving UE displaying an SMS inbox in an exemplary embodiment.

FIG. 7 illustrates a receiving UE prompting an end user for a password in an exemplary embodiment.

FIG. 8 illustrates a receiving UE granting access to an SMS message to an end user in an exemplary embodiment.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

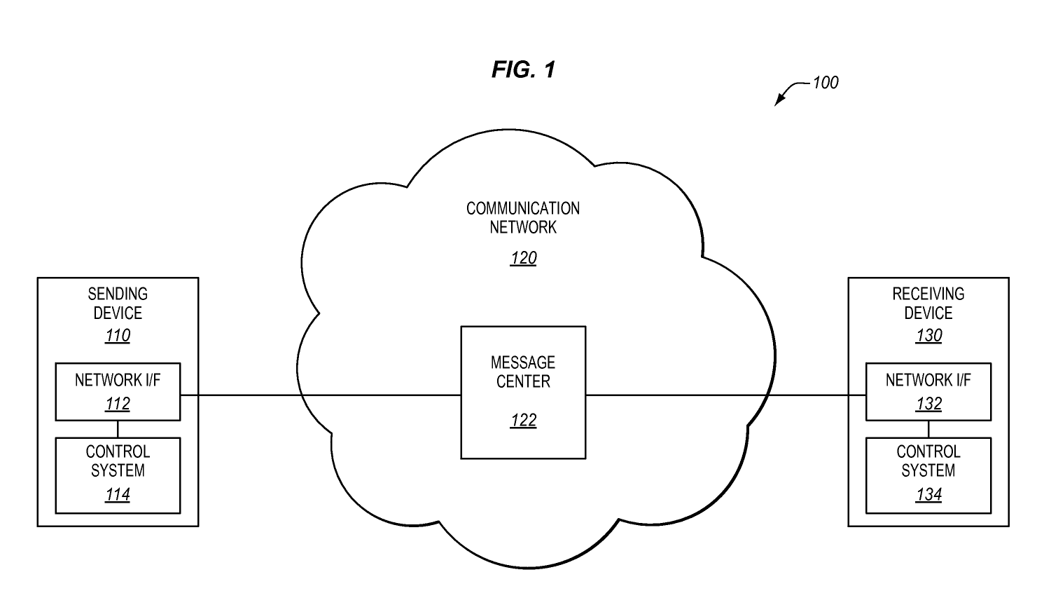

FIG. 1 illustrates a communication system 100 in an exemplary embodiment. Communication system 100 includes a sending device 110 for a text message, a communication network 120 for transporting the text message, and a receiving device 130 for receiving the text message. Sending device 110 comprises any system, server, or end user device operable to initiate delivery of a text message to one or more recipients. Sending device 110 may comprise an end user device (or User Equipment (UE)), such as a cell phone. Sending device 110 may also comprise an automated message center that generates text messages, such as an External Short Messaging Entity (ESME). Typical examples of ESMEs are systems that send automated marketing messages to mobile users, voting systems that process text message votes, etc. In this embodiment, sending device 110 includes a network interface 112 and a control system 114. Network interface 112 comprises any device or component that communicates with communication network 120 for delivering a text message. Control system 114 comprises any device or component that facilitates the insertion of some type of security information into individual text messages that are transmitted from sending device 110.

Communication network 120 provides services to device 110 and devices 130. The services offered and provided by communication network 120 may vary, but at a minimum, devices 110 and 130 have subscriptions for text messaging from communication network 120. Communication network 120 may comprise a circuit-switched mobile or wireline network, such as a CDMA network, a GSM network, a Public Switched Telephone Network (PSTN), etc. Communication network 120 may also comprise a packet-switched network, such as an IP Multimedia Subsystem (IMS) network or a Long Term Evolution (LTE) network. Because communication network 120 may represent different types of networks, devices 110 and 130 may likewise represent different types of devices, such as mobile or cellular devices, wireline devices, SIP phones, a dual mode devices, etc.

In this embodiment, communication network 120 includes a message center 122. Message center 122 comprises any system, server, or device that facilitates delivery of text messages. For example, message center 122 may comprise a Short Message Service Center (SMSC), a Multimedia Message Service Center (MMSC), an IP Short Message Gateway (IP-SM-GW), etc. Because message center 122 may be implemented in multiple locations within network 120, it is merely shown as being included within network 120 and not tied to any specific network node.

Receiving device 130 comprises any system or device operable to receive a text message. Receiving device 130 is an end user device (or UE) in this embodiment, such as a cell phone. The end user as described herein may be the owner of device 130, or another user that has possession of device 130. Receiving device 130 includes a network interface 132 and a control system 134. Network interface 132 comprises any device or component that communicates with communication network 120 for receiving a text message. Control system 134 comprises any device or component that restricts access to text messages based on security information.

In the following embodiments, when sending device 110 sends a text message to receiving device 130, there may be security information (e.g., password or authorized time) associated with the text message. Thus, before an end user of receiving device 130 is able to view or otherwise access the text message, receiving device 130 processes the security information to determine whether access is authorized by this end user, at this time, etc. The security information advantageously provides a layer of protection for text messages received on device 130 so that not every end user of device 130 is able to view the text messages received on device 130.

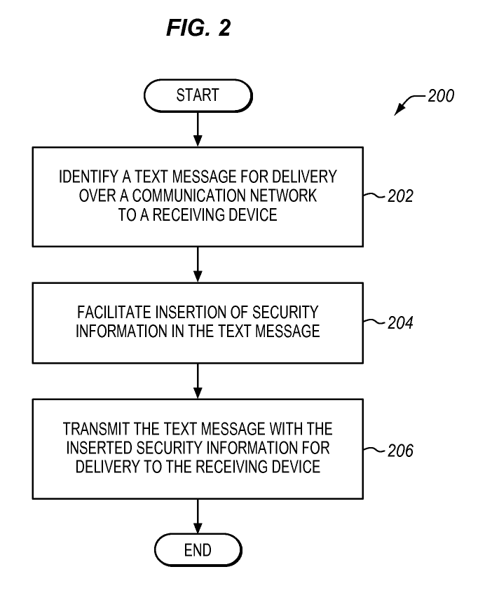

FIG. 2 is a flow chart illustrating a method 200 of associating security information with a text message in an exemplary embodiment. The steps of method 200 will be described with reference to sending device 110 in FIG. 1, but those skilled in the art will appreciate that method 200 may be performed in other networks and systems. The steps of the flow charts described herein are not all inclusive and may include other steps not shown. The steps may also be performed in an alternative order.

In step 202, control system 114 of sending device 110 identifies a text message for delivery over communication network 120 to receiving device 130. Control system 114 may identify the text message when an end user creates a new text message. Control system 114 may identify the text message when an end user selects an existing text message for reply, forward, or a similar function. Still further, control system 114 may identify the text message when an automated application creates a text message.

In step 204, control system 114 facilitates insertion of security information in the text message. Security information comprises any data that controls access to the text message by an end user of a device that receives the text message. The security information may include a password, a PIN, or some other data that is entered by the end user before the text message may be accessed. The security information may also include a time in which access to the text message is authorized, referred to herein as an authorized time. The authorized time may be a time of day and/or day of the week deadline (e.g., 7:00 P.M. on May 20, 2010) that access to the text message is authorized. The authorized time may also be a time frame from when the text message is received that access to the text message is authorized. The security information may comprise any other type of data which controls whether or not an end user of a receiving device may access the text message.

In one embodiment, the security information may be defined or individualized for the text message. This means that the security information controls access to this individual text message. In another embodiment, a group of text messages may share common security information, such as when the group of text messages is generated by the same entity.

Control system 114 may facilitate insertion of the security information in the text message by inserting the security information in a header of the text message (or a signaling message encapsulating the text message). For example, the security information may be predefined or preprogrammed in sending device 110. Thus, control system 114 may identify the predefined security information, and insert the predefined security information in the header of the text message automatically or responsive to a command by an end user. Control system 114 may also provide a user interface that allows the end user to define the security information in real time before sending the text message. To insert the security information in the header, control system 114 may identify an appropriate field or parameter for the security information, and insert the security information in this field.

Control system 114 may also facilitate insertion of the security information in the text message by inserting the security information in a body (or payload) of the text message itself. Again, control system 114 may identify predefined security information, and insert the predefined security information in the body of the text message. Control system 114 may also provide a user interface that allows the end user to define the security information in real time when creating the text message. When the security information is inserted in the body of the text message, delimiting marks, such as “{” and “}”, may placed around the security information to distinguish the security information from the content of the text message. Any desired delimiting marks may be used.

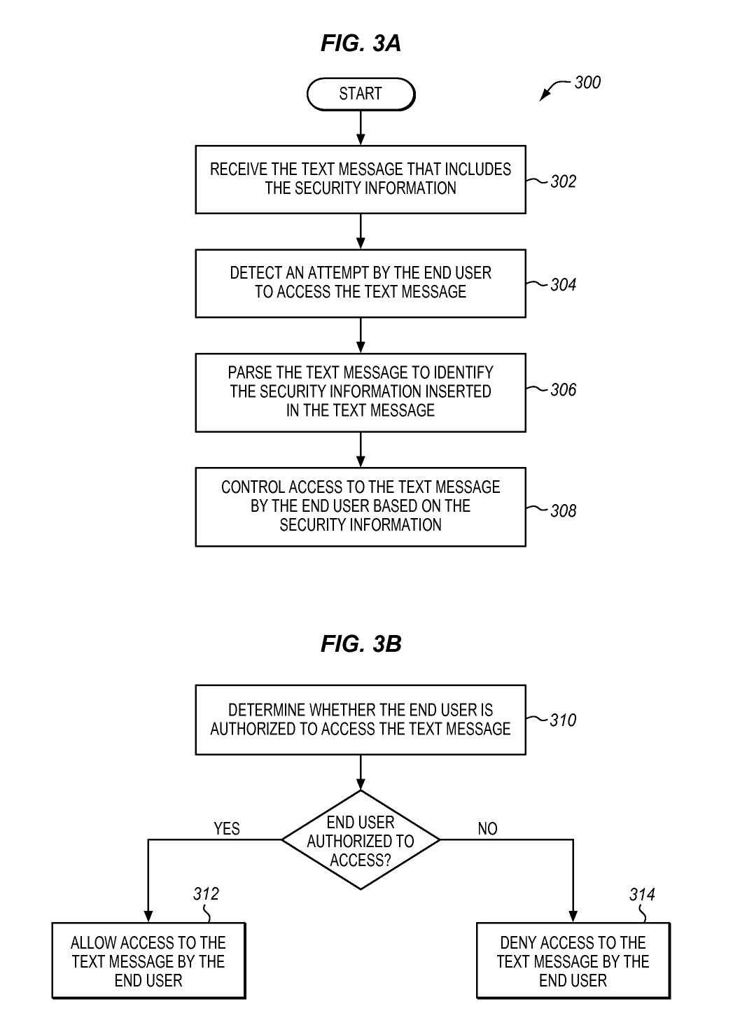

In step 206, network interface 112 transmits the text message with the inserted security information for delivery to receiving device 130. In FIG. 1, network interface 112 may transmit the text message (in the appropriate signaling message) to message center 122 in communication network 120. In response to the text message, message center 122 may perform store-and-forward processing to attempt delivery of the text message to device 130. Receiving device 130 operates as described in FIGS. 3A-B.

FIG. 3A is a flow chart illustrating a method 300 of controlling access to a text message based on security information in an exemplary embodiment. The steps of method 300 will be described with reference to receiving device 130 in FIG. 1, but those skilled in the art will appreciate that method 300 may be performed in other networks, systems, or devices.

In step 302, network interface 132 of receiving device 130 receives the text message from sending device 110. Control system 134 may then store the text message in an inbox within receiving device 130. In step 304, control system 134 detects an attempt by the end user (of receiving device 130) to access the text message. For example, the end user may select the text message from the inbox in an attempt to view the text message. Control system 134 then parses the text message responsive to the access attempt to identify the security information inserted in the text message in step 306. For example, control system 134 may search fields of the header for the security information. Control system 134 may also search the body of the text message for the delimiting marks, and then extract the security information from between the delimiting marks. When the security information is inserted in the body of the text message, control system 134 may remove the security information after it is identified.

In step 308, control system 134 controls access to the text message by the end user of receiving device 130 based on the security information. Controlling access to the text message means that the end user cannot simply view the text message by selecting the text message from the inbox. The text message is protected until one or more conditions are met, according to the security information.

As part of controlling access in FIG. 3B, control system 134 determines whether the end user is authorized to access the text message based on the security information in step 310. If the end user is authorized based on the security information, then control system 134 allows the end user access to the text message in step 312. The end user may then view the text message in a normal fashion. If the end user is not authorized based on the security information, then control system 134 denies the end user access to the text message in step 314. When access is denied, control system 134 may delete the text message or may lock the text message from future access.

In one example, the security information may include a password defined for the text message. As part of controlling access to the text message, control system 134 prompts the end user for the password when the end user attempts to the access the text message. In response to the prompt, control system 134 receives input from the end user. If the input from the end user matches the password defined for the text message, then control system 134 allows access to the text message. If the input from the end user does not match the password (such as after one or more retries), then control system 134 denies access and may delete or lock the text message.

In another example, the security information may include an authorized time defined for the text message during which access to the text message is authorized. For example, the security information may specify that the text message may be accessed for 3 hours after it is received. As part of controlling access to the text message, control system 134 determines if the access attempt occurs during the authorized time. If so, control system 134 allows access to the text message. If not, control system 134 denies access and may delete or lock the text message.

By inserting the security information in the text message, the text message is protected when it is received at receiving device 130. This means that the text message is accessible to authorized end users of receiving device 130. The sender of the text message thus has some control over who can view the text message.

### Example

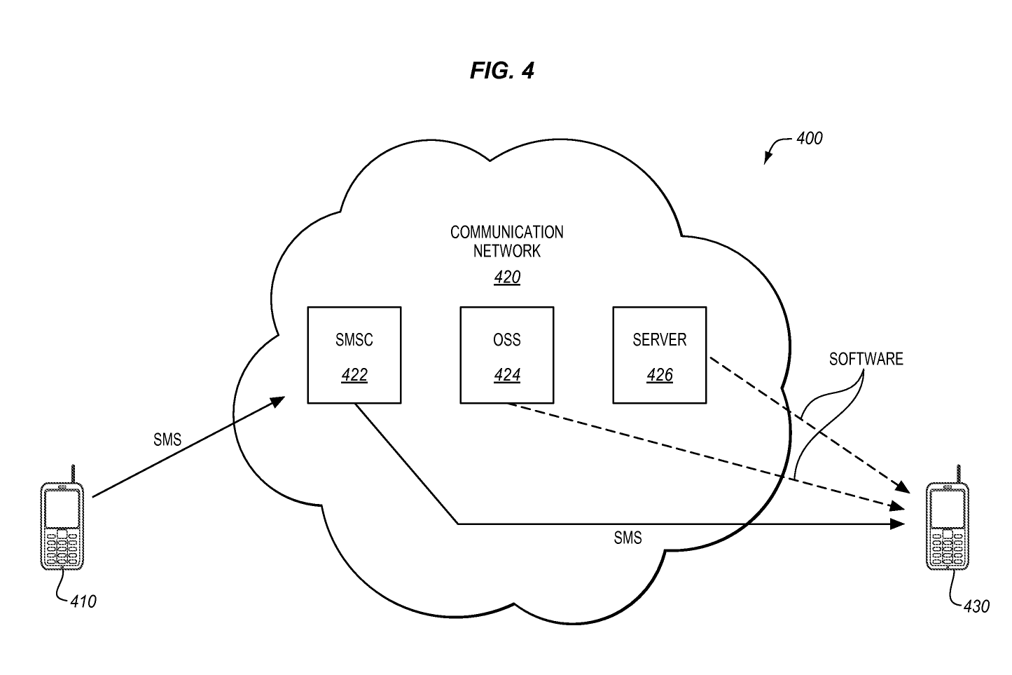

FIG. 4 illustrates a communication system 400 in another exemplary embodiment. Communication system 400 includes a sending UE 410 for sending an SMS message, a communication network 420 for transporting the SMS message, and a receiving UE 430 for receiving the SMS message. Communication system 400 is adapted to provide a protection service for SMS (or MMS) messages that are sent between sending UE 410 and receiving UE 430. In this example, communication network 420 includes an SMS Center (SMSC) 422, an Operations Support System (OSS) 424, and a server 426 that stores an application (or software) for the protection service. With this protection service, when an end user of sending UE 410 sends an SMS message, the end user can specify a password and authorized time for the SMS message. When receiving UE 430 receives the SMS message, the end user of receiving UE 430 will be prompted to provide the password in order to view the SMS message. If the end user doesn't read the SMS message within the authorized time, then the SMS message will be automatically deleted or locked. If the end user reads and saves the SMS message, the end user will no longer be able to read the SMS even with the correct password after the authorized time expires.

In FIG. 4, SMSC 422 handles SMS messages that are sent by sending UE 410. OSS 424 and server 426 are each able to provide an application to receiving UE 430 in order to implement the protection service. OSS 424 is maintained by the service provider and is able to send the application to receiving UE 430 when the subscription begins. Server 426 represents the service provider's website, which receiving UE 430 can securely access to download the application. When the owner of receiving UE 430 subscribes to the protection service, receiving UE 430 may download the application from OSS 424 or server 426 via Over the Air (OTA) or the internet.

When the end user of sending UE 410 wants to send a protected SMS message to receiving UE 430 (the protected SMS message is referred to as a PTC (Password and Time Control) SMS message), the end user enters security information at the beginning of the SMS message. In this example, the security information is a password and authorized time that are entered into the body of the SMS message between delimiting marks. The format of the security information may be as follows:

{PC stringX, TC stringY}, where “{ }” are used to identify the security information, PC stands for Password Control, TC stands for Time Control, stringX represent a password character string, and stringY represent a date and time.

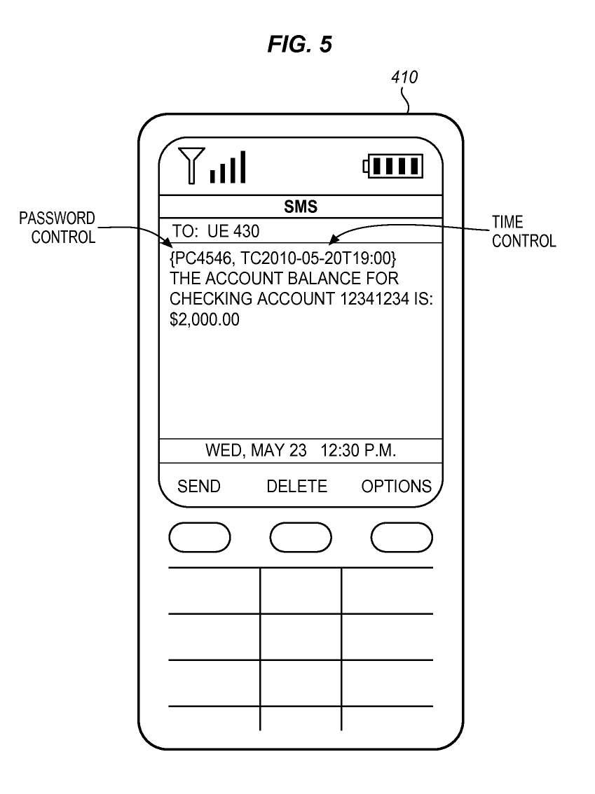

FIG. 5 illustrates sending UE 410 displaying security information entered into an SMS message in an exemplary embodiment. In FIG. 5, the end user has entered the security information of: {PC 4546, TC 2010-05-20T19:00}. The password is 4564, and the authorized time (or time constraint) is May 20, 2010, 7:00 P.M. The end user also entered content for the SMS message, which is: THE ACCOUNT BALANCE FOR CHECKING ACCOUNT 12341234 IS: $2,000.00. When the SMS message is complete, sending UE 410 sends the SMS message to SMSC 422 (see FIG. 4). SMSC 422 performs store-and-forward processing to attempt delivery of the SMS message to receiving UE 430.

One assumption is that the end user of sending UE 410 will notify one or more authorized end users of receiving UE 430 of the password required to access the SMS message. This may occur in a separate SMS message, a voice call, an email, etc.

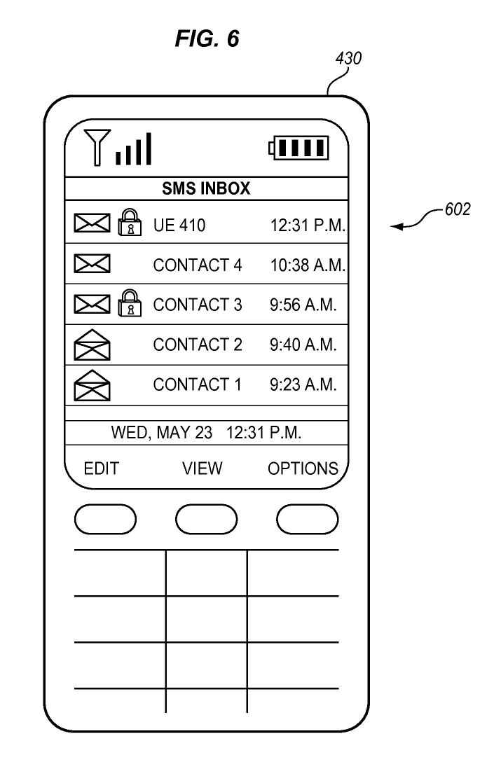

Receiving UE 430 then receives the SMS message from SMSC 422, and places the SMS message in an SMS inbox. FIG. 6 illustrates receiving UE 430 displaying an SMS inbox in an exemplary embodiment. The inbox for receiving UE 430 includes multiple unread messages (indicated by a closed envelope icon). Some of the unread messages are protected according to the protection service, which is indicated by a lock icon. The top SMS message 602 in the inbox represents the SMS message sent by sending UE 410.

If an end user of receiving UE 430 attempts to access SMS message 602, then receiving UE 430 detects the access attempt (based on the application that was downloaded). Receiving UE 430 then parses SMS message 602 to identify any security information that may be inserted in SMS message 602. In this example, receiving UE 430 detects the delimiting marks “{” and “}” in the body of SMS message 602 (see also FIG. 5), and extracts the PC string and TC string at the beginning of the message. Receiving UE 430 then controls access to SMS message 602 based on the password and authorized time indicated in the PC string and the TC string.

After identifying the security information in SMS message 602, receiving UE 430 checks if the present time is later than the time specified in the TC string. If yes, receiving UE 430 deletes the SMS message from the inbox, and may display a notification such as “the content of this SMS message is no longer valid and has been deleted due to time expiration”. If the present time is before the time specified in the TC string, then receiving UE 430 prompts the end user for a password.

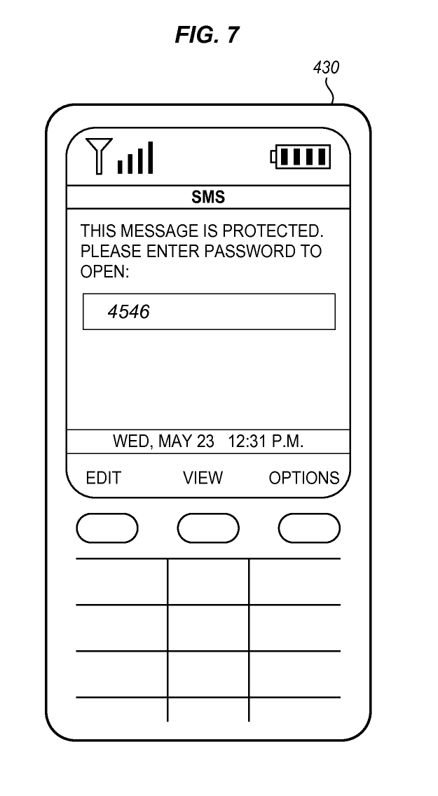

FIG. 7 illustrates receiving UE 430 prompting the end user for a password in an exemplary embodiment. The end user then enters data for the password prompt. If the input by the end user does not match the password specified in the PC string (such as after one or more retries), then receiving UE 430 denies access to the SMS message. Receiving UE 430 may display a notification, such as “you are not allowed to read this SMS message”. Receiving UE 430 may also delete or lock the SMS message. The end user may ask the operator/system to unlock the SMS message if they have a good reason to read the SMS message. For example, an authorized person (such as parents) may request that an SMS message is unlocked based on given conditions.

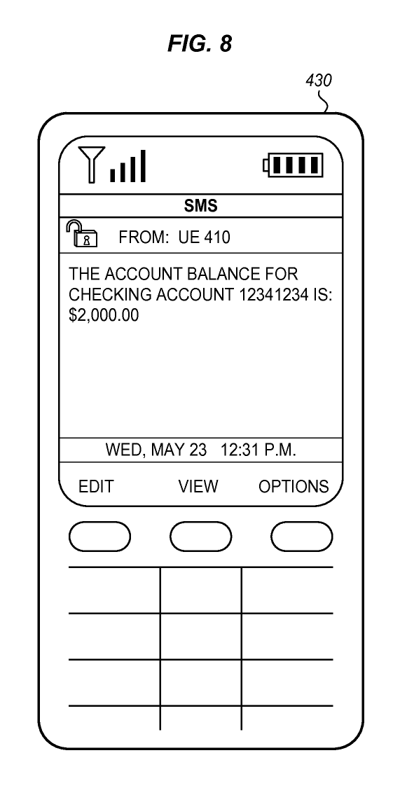

If the input by the end user matches the password specified in the PC string, then receiving UE 430 allows access to the SMS message. In FIG. 7, the end user has entered “4546” as a password. Because this input matches the PC string, receiving UE 430 allows access to the SMS message. FIG. 8 illustrates receiving UE 430 granting access to SMS message 602 to the end user in an exemplary embodiment. The SMS message is now open for viewing by the end user.

When the SMS message has been opened by the end user, receiving UE 430 may allow the end user to have options regarding the SMS message. The end user may keep the original password, edit the password, or remove the password. The end user may keep the original authorized time, edit the authorized time, or remove authorized time.

Although the above example describes an SMS message from one end user to another, the protection service works equally well for automated SMS applications. Before an automated SMS application (such as in a bank) sends out SMS messages, the owner of receiving UE 430 may predefine a password. For example, the owner may predefine an SMS password in a bank account profile for billing statements, transaction confirmations, account warnings, etc. When the automated SMS application for the bank sends out an SMS message to receiving UE 430, the application inserts the predefined password into the SMS message before sending the SMS message. Thus, SMS messages originating from the bank will be password protected so that only authorized end users of receiving UE 430 can access the SMS messages.

The protection service described above advantageously controls which end users of receiving UE 430 are able to view SMS messages. This is a very useful service considering SMS usage is soaring worldwide, and SMS security and privacy protection have become a big issue.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the invention is not limited to those specific embodiments. The scope of the invention is defined by the following claims and any equivalents thereof.

We claim:

1. A system comprising:
a receiving device operable to receive a text message from a sending device over a communication network, to detect an attempt by the end user to access the text message, to parse the text message responsive to the access attempt to identify security information inserted in the text message, and to control access to the text message by the end user based on the security information.

2. The system of claim 1 wherein:
the receiving device is further operable to determine whether the end user is authorized to access the text message based on the security information, to allow access to the text message if the end user is authorized based on the security information, and to deny access to the text message if the end user is not authorized based on the security information.

3. The system of claim 2 wherein:
the receiving device is further operable to delete the text message if access is denied.

4. The system of claim 2 wherein:
the receiving device is further operable to lock the text message if access is denied.

5. The system of claim 2 wherein:
the security information includes a password defined for the text message; and
the receiving device is further operable to prompt the end user for the password responsive to the access attempt, to receive input from the end user, and to allow access to the text message if the input from the end user matches the password defined for the text message.

6. The system of claim 2 wherein:
the security information comprises an authorized time defined for the text message during which access to the text message is authorized; and
the receiving device is further operable to determine whether the access attempt occurs during the authorized time, and to allow access to the text message if the attempt by the end user occurs during the authorized time.

7. The system of claim 1 wherein:
the security information is inserted in a header of the text message.

8. The system of claim 1 wherein:
the security information is inserted in the body of the text message.

9. A method comprising:
receiving a text message from a sending device over a communication network;
detecting an attempt by the end user to access the text message;
parsing the text message responsive to the access attempt to identify security information inserted in the text message; and
controlling access to the text message by the end user based on the security information.

10. The method of claim 9 further comprising:
determining whether the end user is authorized to access the text message based on the security information;
allowing access to the text message if the end user is authorized based on the security information; and
denying access to the text message if the end user is not authorized based on the security information.

11. The method of claim 10 further comprising:
deleting the text message if access is denied.

12. The method of claim 10 further comprising:
locking the text message if access is denied.

13. The method of claim 10 wherein:
the security information includes a password defined for the text message; and
the method further comprises:
prompting the end user for the password responsive to the access attempt;
receiving input from the end user; and
allowing access to the text message if the input from the end user matches the password defined for the text message.

14. The method of claim 10 wherein:
the security information comprises an authorized time defined for the text message during which access to the text message is authorized; and
the method further comprises:
determining whether the access attempt occurs during the authorized time;
allowing access to the text message if the attempt by the end user occurs during the authorized time.

15. The method of claim 9 wherein:
the security information is inserted in a header of the text message.

16. The method of claim 9 wherein:
the security information is inserted in the body of the text message.

17. A system comprising:
a sending device operable to identify a text message for delivery over a communication network to a receiving device, to facilitate insertion of security information in the text message, wherein the security information controls access to the text message by an end user of the receiving device, and to transmit the text message with the inserted security information for delivery to the receiving device.

18. The system of claim 17 wherein:
the sending device is operable to provide a user interface which allows an end user of the sending device to insert the security information in a body of the text message.

19. The system of claim 17 wherein:
the sending device is operable to identify predefined security information, and to automatically insert the predefined security information in a header of the text message.

20. The system of claim 17 wherein:
the security information includes at least one of: a password defined for the text message, and an authorized time defined for the text message during which access to the text message is authorized.
